(19) United States
(12) Patent Application Publication
(10) Pub. No.: US 2008/0162724 A1
(43) Pub. Date: Jul. 3, 2008

(54) Direct domain name service query

(75) Inventor: Juha Hietasarka, Suinula (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/647,422

(22) Filed: Dec. 29, 2006

(51) Int. Cl. H04L 29/06

(52) U.S. Cl. 709/245

(57) ABSTRACT

A direct domain name service query, wherein the requesting device requests the IP address of the domain name server authoring the domain name of the destination device. Then, the requesting device requests the IP address of the destination device from the domain name server authoring the domain name of the destination device. By using this procedure the requesting device will always get the correct IP address for the destination device even if it had been changed recently.

### FIELD OF THE INVENTION

The invention relates to data communication network name services.

### BACKGROUND OF THE INVENTION

In data communication networks each device that is connected to the network has at least one IP address or similar. There are different types of addresses, such as IPv4 and IPv6. It is common to these types that they are not easy to remember and thus they are not as user friendly as a name. Thus, most of the devices are assigned a name. This is important particularly to service providing devices, such as web servers. Thus, domain name services were introduced for translating domain names into an IP address. The translation of a domain name into an IP address is called name resolution and the software to perform the translation is called a resolver. Each resolver is configured with the address of a local domain name server. It sends a DNS request message and waits for the server to send a DNS reply. Most resolvers are configured to use UDP (User Datagram Protocol).

Domain name servers may be allocated name spaces for which they are considered authority servers. When an incoming request specifies a name for which that server is an authority, the server replies from its own database. Otherwise, the server temporarily becomes a client of another name server, which may be a root server. When the second server returns a result, the original server sends a copy back to the resolver. The result is cached as it is likely that a similar request will be repeated within a short period of time.

Caching reduces the load on the root servers. In addition to caching, the root servers are replicated around the world and a DNS server uses whichever root server is most responsive. In practice the geographically closest root server usually responds fastest. The name server will not keep the cached information forever and it will discard the information after some period of time. The expiration time is called the time to live, or TTL. Each datum in the DNS database is assigned such a TTL by administrators of the responsible zone.

In addition to regular static IP addresses there are dynamic IP addresses that change as a function of time. Typically a new IP address is acquired when signing on to the network and released when signing of the network. Released IP address may be reassigned to another device. Thus, a dynamic domain name service was introduced. Dynamic DNS allows devices to update their DNS information, such as current IP address, to the DNS system. The dynamic DNS is part of public DNS system like any other DNS. Common motivation to keep the right IP address updated in the DNS is that then other devices are able to find out the address form where the device can be reached at the moment.

Mobile devices typically connect to the Internet from different locations. Thus, the IP address they use typically changes based on location and/or time. The device has its host name in the DNS system, such as “mymobile.serviceprovider.com”. The device updates its address to the dynamic DNS service each time the IP address changes so that the IP address is updated and corresponds with the host name.

When a first device is connecting to a second device, the first device sends a DNS query for the host name of the second device to find out the IP address of the second device before tying the connection. This functionality is actually built in to all IP stack implementations so that the DNS query is invisible to the application level on top of the IP stack level.

The other use for the DNS system can be that devices can use the DNS system to communicate when the devices are online or offline. This is achieved so that before the device leaves the Internet connection, it clears the IP address information in the DNS. If there is some IP address in the DNS for a device the device is considered to be online and in the other case device is considered to be offline.

The problem is that the DNS servers cache information that they are not authoritarian for. This caching time is controlled by the TTL settings in the authoritarian DNS. Typically the TTL is minutes to hours, so the information the first device gets through the DNS can be obsolete.

If the DNS information is old, the first device can try to connect to an address that is no longer used by the second device. The address can be already re-used by another device, but most typically there is no longer any device behind the address and the first device needs to wait for a timeout to figure out the case. Similarly, when the second device connects to the Internet and updates its address to the DNS, the first device still gets information that the second device is not available. After the delay configured to the TTL part of the record, the information is requested from the authoring DNS and the first device can get accurate information. TTL is typically from several minutes to few hours, which is a long time to wait in peer-to-peer systems. This latency is a technical problem addressed by the invention disclosed in the present application.

Sometimes the problem mentioned above is traversed by configuring the TTL to zero. Then the other servers do not cache the information, or the caching time is marginal. The drawback is that this kind of configuration can generate heavy load for the root servers, which is not desirable. However, in some DNS configurations and specific systems TTL=0 or near zero configuration can be used, but it can't be used as a generic solution. In any case there is some change in the delayed information, thus the first device can get wrong information.

Thus, there is a need for a solution that can provide accurate DNS information without causing heavy load on name servers.

### SUMMARY

The invention discloses a direct domain name service query. According to certain embodiments of the present invention the requesting device requests the IP address of the domain name server that is the authority domain name server for the destination device. Then, the requesting device requests the IP address of the destination device from the said authority domain name server for the destination device. By using this procedure the requesting device will always get the correct IP address for the destination device, even if it had been changed recently.

In an embodiment the present invention is implemented on the application level in the requesting device. Thus, some of the applications may use the invention if it was not provided as a part of the operating system configurations.

In an embodiment of the present invention the functionality described above is included in the protocol stack of the requesting device. Thus, all of the applications can use the improved functionality even if the invention is not implemented to the application.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram of an example embodiment of the present invention,

FIG. 2 is a flow chart of a method according to the present invention,

### DETAILED DESCRIPTION OF THE INVENTION

Reference will now be made in detail to the embodiments of the present invention, examples of which are illustrated in the accompanying drawings.

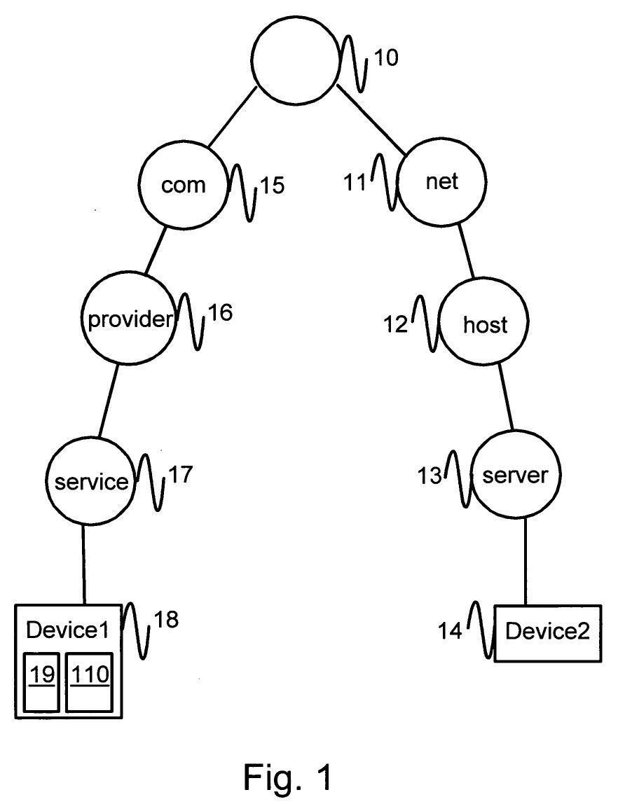

FIG. 1 is a block diagram of a system where principles relating to embodiments of the present invention may be applied. In the figure, a plurality of computers and/or different network elements 10-18 are organized into a network. The network comprises two branches comprising pluralities of network elements. According to the an embodiment of the present invention, a device1 18 may be the requesting device and a device2 14 may be the destination device. Domain name services can be installed to any server acting in the network.

In FIG. 1 it is illustrated how the names of the devices are formed. The complete name of the device1 18 is device1.service.provider.com and the complete name of the device2 14 is device2.server.host.net. These names are just examples and any suitable domain name is allowed, as is evident to persons skilled in the art. In an exemplary embodiment of the present invention the relevant name servers may be located in a network element 17 for device1 18 and in a network element 13 for device2 14. All of the devices in FIG. 1 comprise means for data communications, such as network connections, protocol stacks, network-enabled applications and alike.

In the network of FIG. 1, when device1 18 submits a DNS query it is according to the prior art solution submitted to the closest domain name server 17. If the server 17 is not authoritative for the domain name that is being resolved, the query may be forwarded in the domain name system to servers 16, 15, 10 and so on until the requested information is located. The reply to the query is then submitted to the resolving node, device1 18.

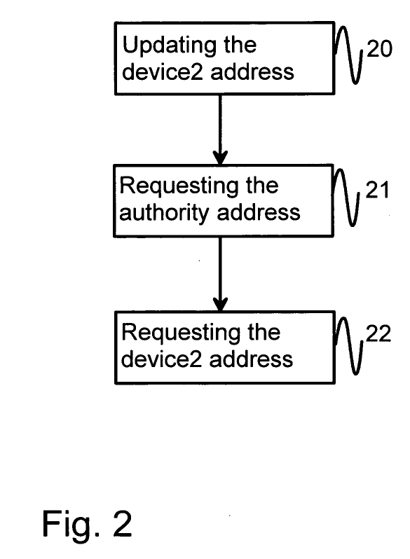

In FIG. 2 a method according to an embodiment of the present invention is disclosed. In the method, first a destination device updates the network address to the domain name service, step 20. The updating may be caused by various reasons, for example, the device may be coming online after being offline or the address is changed because of other reasons. Thus, the device must update the IP-address that corresponds to the device name.

Next the client device begins to initiate communication with the destination device. The client device is associated with a domain name server according to a predetermined network configuration. The client device requests from the domain name server the IP address of a domain name server that is the authority domain name server for the destination device, step 21 (first query). Then the client device requests the IP address of the destination device from the domain name server that is the authority server for the destination device, step 22, by transmitting a DNS query to this server (second query). The DNS query may be transmitted to the authority domain name server using an address acquired as a response to the first query. In an advantageous embodiment the client device transmits the DNS query directly to the authority server using the IP address of the authority server. As a response to the second request the client device receives the IP address of the destination device. When the address is received in this manner, it is always the current, updated address since it is received from the domain name server to which the destination device updates the address.

One way the client device may obtain the IP address of the authority domain name server is to query the domain name system for the server by replacing the destination device name by a predetermined label. For example, in the network illustrated in FIG. 1 the domain name of the destination device is device2.server.host.net. Assuming the label is, for example, “ns”, the client device (Device1) may query the domain name system for the IP address of ns.server.host.net. The label may of course by any agreed, constant alphanumeric sequence such as “nameserver”. If the present invention is unable to resolve the address of the name server by using replacing as described above, it is always possible to revert to conventional resolving.

In a further, advantageous embodiment the resolver 19 in the client device 18 comprises or has access to a memory 110 operable to store the IP addresses of authority DNS servers for destination devices, such that future DNS queries may be transmitted directly to the authority DNS servers of the destination devices, allowing step 22 to be omitted in subsequent queries. The memory 110 may further be configured so, that the stored IP addresses of authority DNS servers are set to expire after a predetermined time, the time being a parameter that may be configured. In the memory 110, the domain names of destination devices may be associated with IP addresses of corresponding authority DNS servers. The memory 110 may be implemented by any suitable means for storing data, such as SDRAM chips, Flash memory or similar. Similar resolver 19 and memory 110 may be included also in the destination device. It must be noted that both of the devices may be also a general purpose servers or other devices including further components. The inventive idea according to the present invention works with all devices using such name service.

In an embodiment the present invention is implemented on the application level. Thus, some of the applications may use the invention if it is not provided as a part of the operating system configurations. In this embodiment the second request is directed to the resolved domain name server instead of the domain name server that is configured to the operating system.

In a further embodiment of the present invention the functionality described above is included in the protocol stack. Thus, all of the applications can use the improved functionality even if the invention is not implemented to the application. The protocol stack implementation can be made fully configurable. Thus, the name service according to the present invention could be implemented, for example, only for IPv4 queries and all the others would request domain name information conventionally.

It is obvious to a person skilled in the art that with the advancement of technology, the basic idea of the invention may be implemented in various ways. The invention and its embodiments are thus not limited to the examples described above; instead they may vary within the scope of the claims.

1. A method comprising:
requesting a first IP address corresponding to an authority domain name server for a destination device from a domain name server associated with a requesting device; and
requesting an IP address of the destination device from the authority domain name server for the destination device.

2. The method according to claim 1, wherein the method further comprises acquiring the IP address of the destination device using an address of the authority domain name server.

3. The method according to claim 1, wherein a portion of a host name of the destination device is used in requesting the IP address of the authority domain name server, wherein a device name is removed from the host name and replaced with a constant alphanumeric sequence.

4. The method according to claim 1, wherein requesting the IP addresses occurs in an application level.

5. The method according to claim 1, wherein requesting the IP addresses occurs in a protocol stack level.

6. The method according to claim 1, the method further comprising updating a destination IP address dynamically.

7. The method according to claim 3, wherein the alphanumeric sequence is ns.

8. A system, comprising:
a requesting device;
a destination device;
first name server, which is associated with the requesting device; and
second name server, which is an authority domain name server for the destination device;
wherein the requesting device is configured to request from the first name server the IP address of the second name server and the requesting device is further arranged to request from the second name server the IP address of the destination device.

9. The system according to claim 8, wherein the requesting device is further configured to acquire the IP address of the destination device using an address of the authority domain name server.

10. An apparatus for data communications, said apparatus comprising:
a first requesting unit configured to request a first IP address corresponding to an authority domain name server for a destination device from a domain name server associated with a requesting device; and
a second requesting unit configured to request an IP address of the destination device from the authority domain name server for the destination device.

11. The apparatus according to claim 10, wherein the apparatus further comprises an acquiring unit configured to acquire the IP address of the destination device using the address of the authority domain name server.

12. The apparatus according to claim 10, wherein the first and second requesting units are configured to use a portion of the host name of the destination device in requesting the IP address of the authority domain name server, wherein the device name is removed from the host name and replaced with a constant alphanumeric sequence.

13. The apparatus according to claim 12, wherein the alphanumeric sequence is ns.

14. The apparatus according to claim 10, wherein the first and second requesting units are implemented in an application level.

15. The apparatus according to claim 10, wherein the first and second requesting units are implemented in a protocol stack level.

16. An apparatus for data communications, wherein the apparatus is configured to:
request a first IP address corresponding to an authority domain name server for a destination device from a domain name server associated with a requesting device; and
request an IP address of the destination device from the authority domain name server for the destination device.

17. The apparatus according to claim 16, wherein the apparatus is further configured to acquire an IP address of the destination device using an address of the authority domain name server.

18. The apparatus according to claim 16, wherein the apparatus is further configured to use a portion of a host name of the destination device in requesting the IP address of the authority domain name server, wherein a device name is removed from the host name and replaced with a constant alphanumeric sequence.

19. The apparatus according to claim 18, wherein the alphanumeric sequence is ns.

20. The apparatus according to claim 16, wherein the apparatus is configured to access a memory for storing the IP addresses of authority domain name servers for destination devices.

21. A computer program comprising program code embodied in a computer readable medium, the program code being configured to control a process to:
request a first IP address corresponding to an authority domain name server for a destination device from a domain name server associated with a requesting device; and
request an IP address of the destination device from the authority domain name server for the destination device.

22. The computer program according to claim 21, wherein the computer program is further configured to perform the acquiring of an IP address of the destination device using an address of the authority domain name server.

23. The computer program according to claim 21, wherein a portion of a host name of the destination device is used in requesting the IP address of the authority domain name server, wherein a device name is removed from the host name and replaced with a constant alphanumeric sequence.

24. The computer program according to claim 23, wherein the alphanumeric sequence is ns.

25. The computer program according to claim 24, wherein the computer program is configured to perform requesting the IP addresses in the application level.

26. The computer program according to claim 24, wherein the computer program is configured to perform requesting the IP addresses in the protocol stack level.

27. A network device, comprising:
means for requesting from a first name server an IP address of a second name server, wherein the first name server is associated with requesting device;
means for further requesting from the second name server an IP address of a destination device, wherein the second name server is the authority domain name server for the destination device.

28. The network device of claim 27 further comprises means for acquiring the IP address of the destination device using the address of the authority domain name server.
